(19) United States
(12) Patent Application Publication
(10) Pub. No.: US 2026/0274229 A1
(43) Pub. Date: Sep. 17, 2026

(54) BRAKE CONTROLLER

(71) Applicant: DELLNER BUBENZER AB, BORLÄNGE (SE)

(72) Inventor: Claes-Göran GUSTAVSSON, VÄSTERÅS (SE)

(21) Appl. No.: 19/166,192

(22) PCT Filed: Jan. 11, 2024
(86) PCT No.: PCT/EP2024/050603

§ 371 Date: Sep. 17, 2025

(30) Foreign Application Priority Data
Mar. 21, 2023 (EP) 23163253.0

(51) Int. Cl. B60T 13/66; B60T 17/22

(52) U.S. Cl. CPC B60T 13/665; B60T 17/228

(57) ABSTRACT

A rail vehicle brake controller (100) receives a brake command (BC), and in response thereto, produces a master control signal (CTRL) that controls an electrically operated brake unit (140) to perform a braking operation. The brake controller (100) contains first and second control units (110; 120) and a gatekeeper unit (130). The first control unit (110) includes a processing circuitry (111) arranged to process the brake command (BC) to produce a first control signal (CTRL1) as a result of running a computer program on the processing circuitry (111). The second control unit (120) includes a state machine (121) arranged to take the brake command (BC) as an input state and produce a second control signal (CTRL2) as an output state resulting from said input state being fed into the state machine (121). The gatekeeper unit (130) receives the first and second control signals (CTRL1; CTRL2), and in response thereto, produces the master control signal (CTRL) if and only if the first and second control signals (CTRL1; CTRL2) fulfil an identity criterion. If the identity criterion is not fulfilled, the gatekeeper unit (130) produces no master control signal (CTRL).

### TECHNICAL FIELD

The present invention relates generally to ensuring the functional integrity of the deceleration system in a rail vehicle. Especially, the invention relates to a brake controller according to the pre-amble of claim 1.

### BACKGROUND

The braking system of a rail vehicle is employed to decelerate the rail vehicle, and usually also to implement a parking brake function. Typically, the same brakes are used both for service braking and emergency braking. Naturally, for all brake functions, it is of utmost importance that the braking system does not malfunction, or fail.

Today's rail vehicles are often regulated using compressed air, known as pneumatically regulated brakes. One disadvantage of such pneumatic brakes is that they cannot be regulated quickly. More important, an air leakage in a pneumatic braking system risks resulting in a severely reduced braking capacity. Therefore, inter alia for safety reasons, various kinds of electrically controlled braking systems begin to emerge on the market.

US 2020/0198605 shows a microcomputer-controlled electromechanical braking system that comprises an electromechanical braking control device and an electromechanical braking unit. The electromechanical braking control device comprises a braking microcomputer control unit, an electromechanical control unit and a standby power supply module. The braking microcomputer control unit receives a braking instruction signal sent by a driver or an automatic driving system, performs the calculation of a target braking force and braking management, and at the same time, can communicate with braking microcomputer control units of other vehicles in a train group.

CN 114200872 discloses a servo motor band-type brake system. having a servo driver with a built-in band-type brake control system. The band-type brake control system comprises: a band-type brake circuit, a micro-control unit (MCU) and a field-programmable gate array (FPGA). The servo driver is connected with the servo band-type brake motor and a man-machine interface used for acquiring and displaying a real-time current signal. The FPGA obtains a real-time current signal of the band-type brake circuit and sends the real-time current signal to the MCU. The MCU receives the real-time current signal sent by the FPGA and sends the real-time current signal to the man-machine interface. The MCU sends a control signal to the band-type brake circuit, and the band-type brake circuit controls the servo band-type brake motor to brake and release according to the control signal. Thus, the actual operation condition of the band-type brake circuit can be visually obtained, and any problems of the band-type brake circuit can be timely and accurately found. The fault rate of the band-type brake circuit is effectively reduced, and the reliability and safety of the band-type brake circuit are improved.

CN201298159 Y describes a digital-signal processor (DSP)-based train electro-pneumatic brake controller, which takes a DSP and an FPGA as the core and adopts an MCU to realize multi-functional real-time communication in a train electro-pneumatic brake controller. The train electropneumatic brake comprises an FPGA chip, a DSP chip and an MCU chip, wherein the FPGA chip is connected with a man-machine interface by 8-bit FPGA buses, connected with a multiple selector, a locker and a D/A converter by 16-bit FPGA buses, connected with the DSP chip and a Static Random Access Memory (SRAM) by 16-bit DSP buses and respectively connected with an analog signal conditioning circuit and a power driving circuit by photoelectric isolation modules. The DSP chip is connected with an A/D converter by a serial peripheral interface (SPI) bus and connected with the MCU chip by an serial communications interface (SCI) communication line. The multiple selector and the locker respectively are connected with a digital signal conditioning circuit by photoelectric isolation modules, and the D/A converter and the A/D converter respectively are connected with the analog signal conditioning circuit by photoelectric isolation modules. The train electropneumatic brake controller adopts the FPGA chip to buffer the data of the buses in different speed degrees so as to satisfy the access sequences of the buses in different speed degrees, has high instantaneity of system control, realizes a plurality of communication modes and improves the instantaneity of communication and the expansibility of the system communication.

Thus, electrically controlled brake systems exist in which various measures are applied to improve the functional reliability. However, there is yet no example of a control system for an electrically controlled rail vehicle brake, where the control system, as such, meets the requirements of international functional safety standards.

### SUMMARY

The object of the present invention is therefore to offer a solution that solves the above problem and enables braking of rail vehicles at a functional integrity with a risk factor and probability of failure on demand being lower than what is prescribed by today's international functional safety standards relating to the rail industry, such as IEC 61508 and EN 50128.

According to one aspect of the invention, the object is achieved by a brake controller for a rail vehicle, which brake controller is configured to receive a brake command and in response thereto produce a master control signal adapted to control an electrically operated brake unit to perform a braking operation. The brake controller contains first and second control units and a gatekeeper unit. The first control unit includes a processing circuitry arranged to process the brake command to produce a first control signal as a result of running a computer program on the processing circuitry.

The second control unit includes a state machine arranged to take the brake command as an input state and produce a second control signal as an output state resulting from said input state being fed into the state machine. The gatekeeper unit is configured to receive the first and second control signals, and in response thereto produce the master control signal if and only if the first and second control signals fulfil an identity criterion. I.e. otherwise, no master control signal is produced.

The above brake controller is advantageous because it ensures that the control signal, which causes the brake to mechanically effect the braking function exclusively reaches the brake unit if this signal is uncorrupted. Namely, the first and second control units are implemented in technologies being functionally diverse from one another and the respective instruction sets according to which the control units operate are fully uncorrelated. Therefore, the risk that the first and second control signals are erroneous in the same way simultaneously is less than 10-12 per hour. This measure meets the highest levels of all existing international safety standards with a margin of several powers of ten.

The state machine may be implemented by an integrated circuit. For example, the integrated circuit may be an FPGA. Preferably, the FPGA, in turn, is designed using a programming language that is different from and logically unrelated to a programming language used to generate the computer program running on the processing circuitry. This ensures a perfect independence between the functionalities of the first and second control units.

According to one embodiment of this aspect of the invention, the gatekeeper unit includes parallel branches of switches. Here, a first switch branch contains a first switch controllable to be open or closed in response to the first control signal and a second switch controllable to be open or closed in response to the second control signal. Similarly, a second switch branch contains a third switch controllable to be open or closed in response to the first control signal and a fourth switch controllable to be open or closed in response to the second control signal. Each of the first and second switch branches is configured to pass through the master control signal if and only if the first and second control signals fulfil the identity criterion, in which case all of the first, second, third and fourth switches are closed. The proposed parallel switch configuration of the gatekeeper unit is advantageous because it provides redundancy to tolerate single switch faults and enables one of the switch branches to be tested while the other one remains in operation.

The first, second, third and fourth switches may be implemented in metal-oxide-semiconductor field-effect transistor (MOSFET) technology, which is a design known to be unfailing and capable of handling high current levels at low losses.

According to another embodiment of this aspect of the invention, each of the first and second control signals may attain discrete values only, which discrete values range from a minimum value to a maximum value. Here, the gatekeeper unit is configured to consider the identity criterion as fulfilled exclusively if the first and second control signals attain the same discrete value. Further, if the identity criterion is fulfilled, the gatekeeper unit is configured to produce the master control signal at a value being identical to said same discrete value. Thereby, a highly reliable master control signal may be fed to the brake unit in a straightforward manner.

For example, the master control signal, in turn, may be configured to control an electric motor such that the electric motor mechanically influences at least one friction member, e.g. mounted on a respective caliper, to move relative to a rotating member, e.g. a brake disc, of the electrically operated brake unit.

Additionally, each of the first and second control units is configured to receive a feedback signal from the electrically operated brake unit, which feedback signal is produced by a force sensor therein. Consequently, the first and second control units may independently evaluate whether or not the master control signal resulted in the desired braking action.

According to another embodiment of this aspect of the invention, each of the first and second control units is configured to produce a respective first and second acknowledgement message in response to the feedback signal. The first and second acknowledgement messages confirm that the braking operation has been effected. The first and second control units are further configured to exchange the first and second acknowledgement messages with one another, and exclusively in one of the first and second control units, produce a master acknowledgement message, if and only if the first and second acknowledgement messages agree on a magnitude of a force at which the braking operation was effected. The magnitude may be indicated in first and second data fields of each of the first and second acknowledgement messages respectively. Hence, a validated feedback message may be sent confirming that the braking action was effected correctly.

Preferably, the first and second acknowledgement messages are considered to agree on the magnitude of the force if a checksum calculated in one of the first and second control units, say the first, based on the first data field in one of the first and second acknowledgement messages, say the first, matches the second data field in the other one of the first and second acknowledgement messages, which said other one message was produced in the other one of the first and second control units. Thus a highly reliable and independent validation may be accomplished in a relatively un-complicated manner.

According to still another embodiment of this aspect of the invention, the brake controller also contains a first motor diagnostic unit that is configured to receive at least one root diagnostic signal from the electric motor. The at least one root diagnostic signal indicates one or more electromagnetic characteristics of the electric motor, e.g. a power consumption, a current circulated through the electric motor, a terminal voltage and/or a magnetic quantity of the electric motor. In response to the at least one root diagnostic signal, the first motor diagnostic unit is configured to produce a first motor diagnostic signal. Moreover, the brake controller contains a second motor diagnostic unit that is configured to receive the at least one root diagnostic signal from the electric motor, and in response thereto produce a second motor diagnostic signal. The first control unit is further configured to: receive the first motor diagnostic signal; produce a first motor-diagnostic acknowledgement message in response thereto, which first motor-diagnostic acknowledgement message reflects the one or more electromagnetic characteristics of the electric motor; forward the first motor-diagnostic acknowledgement message to the second control unit; and receive a second motor-diagnostic acknowledgement message from the second control unit. Analogously, the second control unit is configured to: receive the second motor diagnostic signal; produce the second motor-diagnostic acknowledgement message in response thereto, which second motor-diagnostic acknowledgement message reflects the one or more electromagnetic characteristics of the electric motor; and forward the second motor diagnostic acknowledgement message to the first control unit. The brake controller is configured to produce a master motor-diagnostic acknowledgement message exclusively in one of the first and second control units, and the master motor-diagnostic acknowledgement message is produced if and only if the first and second motor diagnostic acknowledgement messages agree on the one or more electromagnetic characteristics of the electric motor reflected by the first and second motor diagnostic acknowledgement messages respectively. Consequently, a validated feedback message may be generated, which reflects an operational status of the electric motor.

According to one embodiment of this aspect of the invention, the brake controller also contains first and second force-sensor diagnostic units. The first force-sensor diagnostic unit is configured to receive a source diagnostic signal from the force sensor. The source diagnostic signal indicates a functionality characteristic of the force sensor. In response to the source diagnostic signal, the first force-sensor diagnostic unit is configured to produce a first force-sensor diagnostic signal, for example including a checksum generated based on a signal value of the first force-sensor diagnostic signal. Similarly, the second motor diagnostic unit is configured to receive the source diagnostic signal from the electric motor; and in response thereto, produce a second force-sensor diagnostic signal. The first control unit is configured to: receive the first force-sensor diagnostic signal; produce a first force-sensor diagnostic acknowledgement message in response thereto, which first force-sensor diagnostic acknowledgement message reflects the functionality characteristic of the force sensor; forward the first force-sensor diagnostic acknowledgement message to the second control unit; and receive a second force-sensor diagnostic acknowledgement message from the second control unit. The second control unit is configured to: receive the second force-sensor diagnostic signal; produce the second force-sensor diagnostic acknowledgement message in response thereto, which second force-sensor diagnostic acknowledgement message reflects the functionality characteristics of the force sensor; and forward the second force-sensor diagnostic acknowledgement message to the first control unit. Here, the brake controller is configured to produce a master force-sensor diagnostic acknowledgement message exclusively in one of the first and second control units. The master force-sensor diagnostic acknowledgement message is produced if and only if the first and second force-sensor diagnostic acknowledgement messages agree on the functionality characteristics of the force sensor reflected by the first and second force-sensor diagnostic acknowledgement messages respectively. Hence, a validated feedback message may be generated, which reflects a diagnostics of the force sensor.

For instance, the source diagnostic signal may contain a first data field indicating a temperature of at least one component in the electrically operated brake unit and/or a second data field indicating at least one acceleration parameter reflecting a movement of the electrically operated brake unit in at least one dimension. Such parameters are beneficial because they enable conclusions to be made regarding the general health status of the electrically operated brake unit.

According to an additional embodiment of this aspect of the invention, the first control unit is further configured to produce at least one first status signal reflecting at least one operation parameter indicating at least one functional status of at least one internal component of the first control unit and/or at least one environment parameter indicating at least one milieu aspect concerning the first control unit. Analogously, the second control unit is further configured to produce at least one second status signal reflecting at least one operation parameter indicating at least one functional status of at least one internal component of the second control unit and/or at least one environment parameter indicating at least one milieu aspect concerning the second control unit. Here, the brake controller includes a common diagnostic unit configured to: receive the first and second status signals, and produce an alarm message if at least one of the first and second status signals indicates at least one malfunctioning internal component and/or at least one milieu aspect being outside an acceptable range. Thereby, the brake controller, as such, may be adequately monitored.

According to still another embodiment of this aspect of the invention, the brake controller contains first and second voltage modules. The first voltage module is arranged to receive a supply voltage, and in response thereto, provide at least one first output voltage to the first control unit. The second voltage module is arranged to receive the supply voltage and in response thereto, provide at least one second output voltage to the second control unit.

For example, each of the first and second voltage modules may include respective over and under voltage detectors. Each of said over voltage detectors is configured to monitor the supply voltage, and if the supply voltage exceeds a first threshold level, generate an over voltage alarm. Each of said under voltage detectors is configured to monitor the supply voltage, and if the supply voltage falls below a second threshold level, generate an under voltage alarm. Thus, any unacceptable deviations in the supply voltage may be detected and reported to a relevant supervision function.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 shows a block diagram illustrating a brake controller and an electrically operated brake unit according to a first embodiment of the invention;

FIG. 2 shows a schematic illustration of a gatekeeper unit according to one embodiment of the invention;

FIG. 3 illustrates a principle of how an output signal from a force sensor may be handled according to one embodiment of the invention; and

FIG. 4 shows a block diagram illustrating a brake controller according to further embodiments of the invention.

### DETAILED DESCRIPTION

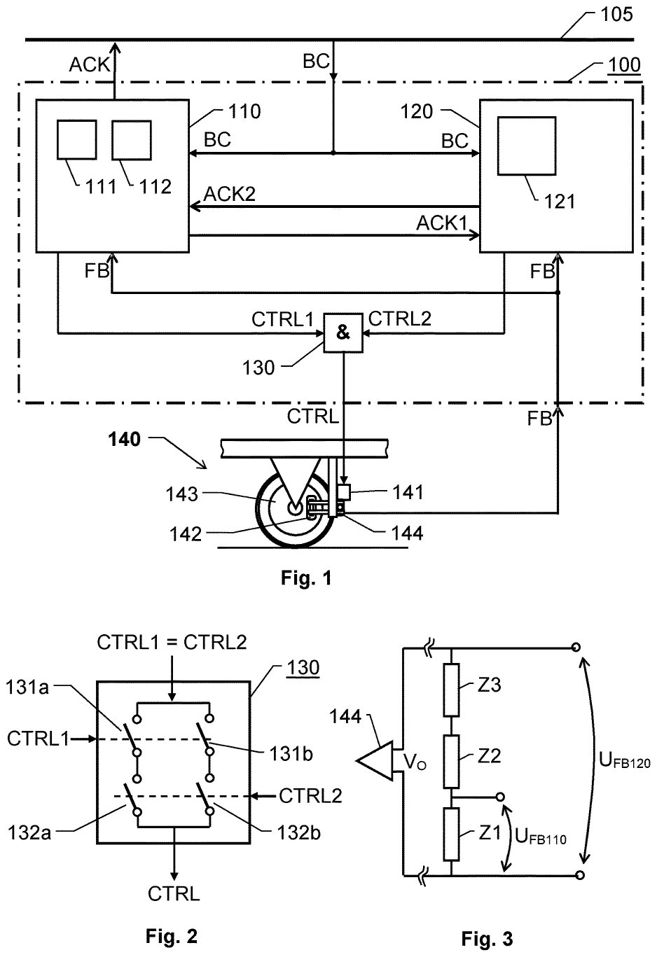

In FIG. 1, we see a block diagram illustrating a brake controller 100 arranged to control an electrically operated brake unit 140 in a rail vehicle according to one embodiment of the invention.

The brake controller 100 is configured to receive a brake command BC, which for example is generated by a train driver and forwarded to the brake controller 100 via a data bus 105 in the rail vehicle. In response to the brake command BC, the brake controller 100 is configured to produce a master control signal CTRL, which, in turn, is adapted to control the electrically operated brake unit 140 to perform a braking operation, for example applying a particular brake force. However, according to the invention, the braking operation may also involve releasing or reducing an already applied brake force.

The brake controller 100 contains first and second control units 110 and 120 respectively and a gatekeeper unit 130. According to the invention, the first and second control units 110 and 120 are implemented in technologies being functionally diverse from one another and the respective instruction sets according to which the control units operate are fully uncorrelated.

Specifically, the first control unit 110 includes a processing circuitry 111 that is arranged to process the brake command BC to produce a first control signal CTRL1 as a result of running a computer program on the processing circuitry 111. The computer program is preferably stored in a memory unit 112 communicatively connected to the processing circuitry 111, which memory unit 112 may be included in the first control unit 110.

The second control unit 120 includes a state machine 121, which is arranged to take the brake command BC as an input state and produce a second control signal CTRL2 as an output state resulting from the input state being fed into the state machine 121.

The state machine may be implemented by an integrated circuit, which for example is an FPGA. Preferably, the FPGA, in turn, is designed using a programming language that is different from and logically unrelated to a programming language used to generate the computer program running on the processing circuitry 111. This ensures perfect independence between the first and second control units.

The first and second control units 110 and 120 are designed to implement identical functionality. This means that if a particular brake command BC is fed into the first and second control units 110 and 120, these units shall produce the exact same output control signals. In other words, unless an error or malfunction occurs, the first control signal CTRL1 shall always be identical to the second control signal CTRL2.

The gatekeeper unit 130 is configured to receive the first and second control signals CTRL1 and CTRL2 respectively. In response to these signals, the gatekeeper unit 130 is configured to produce the master control signal CTRL. However, the master control signal CTRL is only produced if the first and second control signals CTRL1 and CTRL2 fulfil an identity criterion.

Referring now to FIG. 2 showing a schematic illustration of the gatekeeper unit 130 according to one embodiment of the invention.

Here, the gatekeeper unit 130 contains two parallel branches of switches, where a first branch of switches includes first and second switches 131a and 132a respectively, and a second branch of switches includes third and fourth switches 131b and 132b respectively. The first switch 131a is controllable to be open or closed in response to the first control signal CTRL1 and the second switch 132a is controllable to be open or closed in response to the second control signal CTRL2. The third switch 131b is controllable to be open or closed in response to the first control signal CTRL1 and the fourth switch 132b is controllable to be open or closed in response to the second control signal CTRL2.

As illustrated in FIG. 2, each of the first and second branches of switches is configured to pass through the master control signal CTRL if and only if the first and second switches 131a and 132a and the third and fourth switches 131b and 132b respectively are closed. The first and third switches 131a and 131b are controlled in response to the first control signal CTRL1, and the second and fourth switches 132a and 132b are controlled in response to the second control signal CTRL2. In particular, the first, second, third and fourth switches 131a, 131b, 132a and 132b are controlled to be closed if and only if the first and second control signals CTRL1 and CTRL2 fulfil the identity criterion. In such a case, said switches pass through the master control signal CTRL being identical to each of the first and second control signals CTRL1 and CTRL2.

The schematic configuration of the gatekeeper unit 130 illustrated in FIG. 2 is advantageous because the parallel branches of switches provide a redundancy that allows the gatekeeper unit 130 to function also if any single one of the first, second, third or fourth switches 131a, 131b, 132a or 132b fails. Moreover, the parallel design enables the switches in one of the branches to be tested while the switches in the other branch remain operational.

For example the first, second, third and fourth switches 131a, 132a, 131b and 132b may be implemented in MOSFET technology. This is beneficial because MOSFET switches are comparatively fail-safe, and are capable of handling relatively high currents. MOSFET switches are also advantageous because they have a relatively small Ros(on) value, i.e. low resistance when being switched on, which equals low losses and negligible impact on the signals being forwarded.

For further improved reliability, it is preferable if the first, second, third and fourth switches 131a, 132a, 131b and 132b are implemented in at least two separate components, e.g. with one component per branch of switches in the gatekeeper unit 130.

According to one embodiment of the invention, each of the first and second control signals CTRL1 and CTRL2 may exclusively attain discrete values, which range from a minimum value to a maximum value. The gatekeeper unit 130 is here configured to consider the identity criterion as fulfilled if and only if the first and second control signals CTRL1 and CTRL2 attain the same discrete value. If the identity criterion is fulfilled, the gatekeeper unit 130 is configured to produce the master control signal CTRL at a value being identical to said same discrete value. In other words, the master control signal is produced such that CTRL=CTRL1=CTRL2.

For instance, the first and second control signals CTRL1 and CTRL2 as well as the master control signal CTRL may be embodied as respective direct currents in response to whose magnitude an electric motor 141, e.g. a stepper motor or a brushless DC motor, mechanically influences at least one friction member 142, e.g. brake pads mounted on calipers, to move relative to a rotating member 143, e.g. a brake disc, of the electrically operated brake unit 140. Should for example the electric motor 141 be a stepper motor, the direct current represented by the master control signal CTRL may designate a number of angular steps that an axis of the stepper motor shall take to mechanically influence at least one friction member 142, preferably via a gear-shaft mechanism.

According to one embodiment of the invention, each of the first and second control units 110 and 120 is configured to receive a feedback signal FB from the electrically operated brake unit 140. The feedback signal FB is produced by a force sensor 144 of the electrically operated brake unit 140. The force sensor 144, which is symbolically illustrated in FIG. 3 may for example be of load-cell type or strain-gauge type. Typically, the force sensor 144 generates an output signal in the form of a voltage V_{O} indicative of a force exerted on a sensing probe. Naturally, the force sensor 144 is configured to register both positive and negative variations in force, i.e. increases as well as decreases. Thus, the voltage V_{O} may be elevated or lowered as function of time depending on the brake commands BC being effected.

FIG. 3 exemplifies how the voltage V_{O} from the force sensor 144 representing the feedback signal FB may be received by the first and second control units 110 and 120. Here, the first control unit 110 receives a first fraction of the voltage V_{O}, which first fraction is registered as a voltage U_{FB110} over a first resistive element Z1 of an impedance ladder. The second control unit 120 receives the full voltage V_{O} as a voltage V_{FB210} over the first resistive element Z1 plus two additional resistive elements Z2 and Z3 of the impedance ladder. The relationship between the resistance value of the first resistive element Z1 and the total resistance value of the two additional resistive elements Z2 and Z3 is known to the first control unit 110. Consequently, the first control unit 110 may unambiguously derive the voltage V_{O} from the voltage U_{FB110}.

Analogous to the above, the first and second control units 110 and 120 exchange their respective measurements of the voltage V_{O} with one another; and should the voltage value derived in the first control unit 110 differ from the voltage U_{FB120} registered by the second control unit 120, this indicates that at least one of the resistive elements Z1, Z2 and Z3 in the impedance ladder is faulty.

According to one embodiment of the invention, each of the first and second control units 110 and 120 respectively is further configured to produce a respective first and second acknowledgement message ACK1 and ACK2 in response to the feedback signal FB. The first and second acknowledgement messages ACK1 and ACK2 confirm that the braking operation has been effected, for example by returning a respective force value. The first and second control units 110 and 120 are further configured to exchange the first and second acknowledgement messages ACK1 and ACK2 with one another to verify whether they agree, e.g. indicate the same force value. If and only if the first and second acknowledgement messages ACK1 and ACK2 agree on a magnitude of a force at which the braking operation was effected, exclusively one of the first and second control units 110 and 120, say the first control unit 110, is configured to produce a master acknowledgement message ACK, which indicates a force magnitude equal to what is indicated by each of the first and second acknowledgement messages ACK1 and ACK2, for example in first and second data fields respectively thereof.

According to one embodiment of the invention, the first and second acknowledgement messages ACK1 and ACK2 are considered to agree on the force magnitude if a checksum calculated in one of the first and second control units, say 110, based on the first data field in one of the first and second acknowledgement messages ACK1 matches the second data field in the other one of the first and second acknowledgement messages ACK2, which was produced in the other one of the first and second control units, say 120.

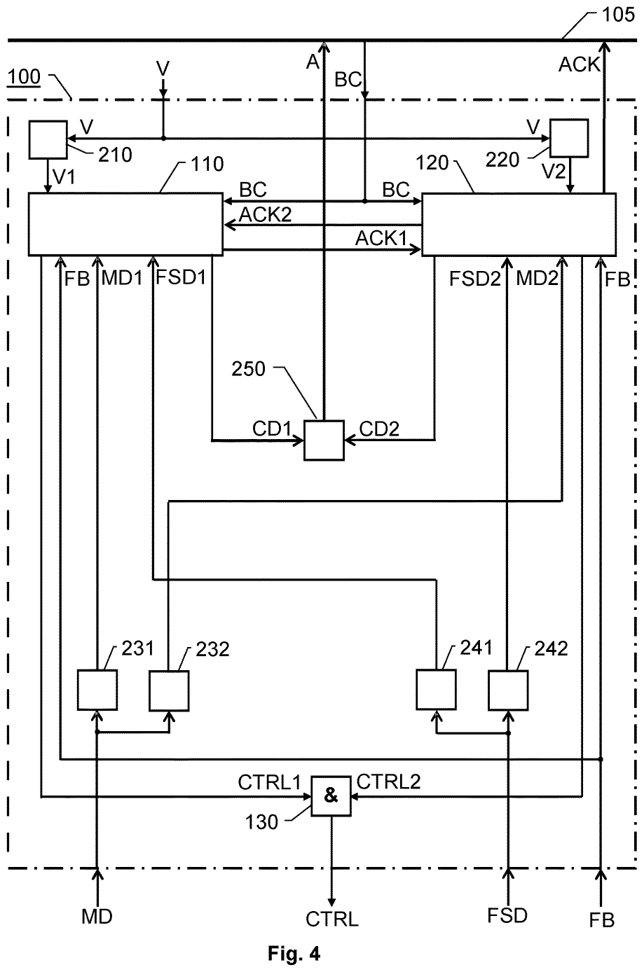

FIG. 4 shows a block diagram illustrating the brake controller 100 according to further embodiments of the invention. In FIG. 4, all entities, commands, signals and messages that also occur in FIGS. 1 to 3 designate the same entities, commands, signals and messages as described above referring to FIGS. 1 to 3.

In one embodiment of the invention illustrated in FIG. 4, the brake controller 100 contains first and second motor diagnostic units 231 and 232 respectively. The first motor diagnostic unit 231 is configured to receive at least one root diagnostic signal MD from the electric motor 141. The at least one root diagnostic signal MD indicates one or more electromagnetic characteristics of the electric motor 141, such as a power consumed by the electric motor 141, a current circulated through the electric motor 141, a terminal voltage at the electric motor 141 and/or a magnetic quantity of the electric motor 141, e.g. a magnetic field component registered by a Hall sensor or similar sensor. In response to the at least one root diagnostic signal MD, the first control unit 110 is configured to produce a first motor diagnostic signal MD1 that either summarizes the information carried by the at least one root diagnostic signal MD, or indicates-binary-whether or not the at least one root diagnostic signal MD lie within acceptable ranges.

The second motor diagnostic unit 232 is also configured to receive the at least one root diagnostic signal MD from the electric motor 141, and in response thereto, produce a second motor diagnostic signal MD2 whose format is identical to the format of the first motor diagnostic signal MD2.

Here, the first control unit 110 is configured to receive the first motor diagnostic signal MD1, and in response thereto, produce a first motor-diagnostic acknowledgement message, symbolized as ACK1 in FIG. 4. The first motor-diagnostic acknowledgement message reflects the one or more electromagnetic characteristics of the electric motor 141, for instance in the form of a summary or as a binary parameter analogous to the above. The first control unit 110 is also configured to forward the first motor-diagnostic acknowledgement message to the second control unit 120, and receive a second motor-diagnostic acknowledgement message from the second control unit 120.

Similarly, the second control unit 120 is configured to receive the second motor diagnostic signal MD2, and in response thereto produce the second motor-diagnostic acknowledgement message, symbolized as ACK2 in FIG. 4. The second motor-diagnostic acknowledgement message reflects the one or more electromagnetic characteristics of the electric motor 141 on the same format as the first motor-diagnostic acknowledgement message. Additionally, the second control unit 120 is also configured to forward the second motor diagnostic acknowledgement message to the first control unit 110.

If and only if the first and second motor diagnostic acknowledgement messages agree on each of the one or more electromagnetic characteristics of the electric motor 141 reflected by the first and second motor diagnostic acknowledgement messages respectively, the brake controller 100 is configured to produce a master motor-diagnostic acknowledgement message. Specifically, the master motor-diagnostic acknowledgement message is exclusively produced in one of the first and second control units, for instance 110 as symbolized by ACK in FIG. 4.

According to one embodiment of the invention, the brake controller 100 includes first and second force-sensor diagnostic units 241 and 242 respectively, which each is configured to receive a source diagnostic signal FSD from the force sensor 144. The source diagnostic signal FSD indicates a functionality characteristic of the force sensor 144, For example the source diagnostic signal FSD may contain first and second data fields, where the first data field indicates a temperature of at least one component in the electrically operated brake unit 140, and the second data field indicates at least one acceleration parameter reflecting a movement of the electrically operated brake unit 140 in at least one dimension. It is generally beneficial to monitor temperatures because if a component's/unit's temperature level deviates from the temperature levels of its neighboring components/units, this typically indicates that the component/unit whose temperature deviates is faulty, for example due to mechanical and/or electrical overload. By monitoring the acceleration in at least one dimension, conclusions may be drawn whether the registered acceleration matches an expected acceleration resulting from a latest brake command BC received.

In response to the source diagnostic signal FSD, the first and force-sensor diagnostic unit 241 is configured to produce a first force-sensor diagnostic signal FSD1, and the second motor diagnostic unit 242 is configured to produce a second force-sensor diagnostic signal FSD2.

Here, the first control unit 110 is configured to receive the first force-sensor diagnostic signal FSD1, and in response thereto, produce a first force-sensor diagnostic acknowledgement message reflecting the functionality characteristic of the force sensor 144, for example as a binary parameter indicating whether or not the functionality characteristic lies within an acceptable range. The first control unit 110 is further configured to forward the first force-sensor diagnostic acknowledgement message to the second control unit 120, and receive a second force-sensor diagnostic acknowledgement message from the second control unit 120.

Analogously, the second control unit 120 is configured to receive the second force-sensor diagnostic signal FSD2, and in response thereto, produce the second force-sensor diagnostic acknowledgement message, which reflects the functionality characteristics of the force sensor 144. Further, the second control unit 120 is configured to forward the second force-sensor diagnostic acknowledgement message to the first control unit 110.

The brake control unit 100 is configured to produce a master force-sensor diagnostic acknowledgement message if and only if the first and second force-sensor diagnostic acknowledgement messages agree on the functionality characteristics of the force sensor 144 reflected by the first and second force-sensor diagnostic acknowledgement messages respectively. The master force-sensor diagnostic acknowledgement message is exclusively produced in one of the first and second control units, for example 110 as symbolized in FIG. 4 by ACK.

Furthermore, according to one embodiment of the invention shown in FIG. 4, the first control unit 110 is configured to produce at least one first status signal CD1, which reflects at least one operation parameter indicating at least one functional status of at least one internal component of the first control unit 110 itself and/or at least one environment parameter indicating at least one milieu aspect concerning the first control unit 110. Analogously, the second control unit 120 is configured to produce at least one second status signal CD2 reflecting at least one operation parameter indicating at least one functional status of at least one internal component of the second control unit 120 and/or at least one environment parameter indicating at least one milieu aspect concerning the second control unit 120. For example, the at least one functional status of the at least one internal component of the first and second control units 110 and 120 may relate to power consumption, input current and/or supply voltage; and the at least one milieu aspect may for example relate to ambient temperature and/or air humidity.

Here, the brake controller 100 also contains a common diagnostic unit 250, which is configured to receive the first and second status signals CD1 and CD2 respectively, and produce an alarm message A if at least one of the first and second status signals CD1 and CD2 indicates one or more malfunctioning internal components and/or that at least one milieu aspect is outside an acceptable range, for instance that the ambient temperature is too high.

According to yet another embodiment of the invention shown in FIG. 4, the brake controller 100 contains first and second voltage modules 210 and 220 respectively.

The first voltage module 210 is arranged to receive a supply voltage V, e.g. 28 V, and in response thereto, provide at least one first output voltage V1, e.g. 1.25 V, 1.5 V, 1.6 V, 1.8 V, 2 V, 3 V, 3.3 V, 3.6 V, 4.5 V, 5 V, 6 V, 9 V, 10 V, 12 V, 13.8 V, 24 V, 27 V and/or 28 V to the first control unit 110, and possibly the gatekeeper unit 130 and/or one or more of the units 231, 231, 241, 242 and/or 250 potentially included in the brake controller 100. The second voltage module 220 is arranged to receive the supply voltage V, e.g. 28 V, and in response thereto, provide at least one second output voltage V2 e.g. 1.25 V, 1.5 V, 1.6 V, 1.8 V, 2 V, 3 V, 3.3 V, 3.6 V, 4.5 V, 5 V, 6 V, 9 V, 10 V, 12 V, 13.8 V, 24 V, 27 V and/or 28 V to the second control unit 120, and possibly the gatekeeper unit 130 and/ or one or more of the units 231, 231, 241, 242 and/or 250 potentially included in the brake controller 100.

Preferably, each of the first and second voltage modules 210 and 220 includes a respective over voltage detector and a respective under voltage detector. Each of the over voltage detectors is configured to monitor the supply voltage V, and if the supply voltage V exceeds a first threshold level; generate an over voltage alarm and disconnect the units connected thereto to protect these units from harmful voltages. Each of the under voltage detectors is also configured to monitor the supply voltage V, and if the supply voltage V falls below a second threshold level; generate an under voltage alarm.

The brake controller 100 is preferably configured to produce the above-described diagnostic acknowledgement messages at regular intervals, say once every 20 ms, via the data bus 105. As explained in this disclosure, no diagnostic acknowledgement message is sent out on the data bus 105 if the underlying diagnostic acknowledgement messages from the first and second control units 110 and 120 disagree. Consequently, should a superior function arranged to monitor the diagnostic acknowledgement messages from the brake controller 100 fail to receive a diagnostic acknowledgement message on the data bus 105 within an expected interval, the superior function is preferably configured to set an alarm indicating a malfunction in the brake controller 100, which malfunction relates to the missing diagnostic acknowledgement message. Thereby, it is possible to identify any faults in the braking system highly accurately and at very short delays.

Variations to the disclosed embodiments can be understood and effected by those skilled in the art in practicing the claimed invention, from a study of the drawings, the disclosure, and the appended claims.

The term “comprises/comprising” when used in this specification is taken to specify the presence of stated features, integers, steps or components. The term does not preclude the presence or addition of one or more additional elements, features, integers, steps or components or groups thereof. The indefinite article “a” or “an” does not exclude a plurality. In the claims, the word “or” is not to be interpreted as an exclusive or (sometimes referred to as “XOR”). On the contrary, expressions such as “A or B” covers all the cases “A and not B”, “B and not A” and “A and B”, unless otherwise indicated. The mere fact that certain measures are recited in mutually different dependent claims does not indicate that a combination of these measures cannot be used to advantage. Any reference signs in the claims should not be construed as limiting the scope.

It is also to be noted that features from the various embodiments described herein may freely be combined, unless it is explicitly stated that such a combination would be unsuitable.

The invention is not restricted to the described embodiments in the figures, but may be varied freely within the scope of the claims.

1. A brake controller (100) for a rail vehicle, which brake controller (100) is configured to receive a brake command (BC) and in response thereto produce a master control signal (CTRL) controlling an electrically operated brake unit (140) to perform a braking operation, wherein the brake controller (100) comprises:
a first control unit (110) comprising a processing circuitry (111) arranged to process the brake command (BC) to produce a first control signal (CTRL1) as a result of running a computer program on the processing circuitry (111);
a second control unit (120) comprising a state machine (121) arranged to take the brake command (BC) as an input state and produce a second control signal (CTRL2) as an output state resulting from said input state being fed into the state machine (121); and
a gatekeeper unit (130) configured to receive the first and second control signals (CTRL1; CTRL2), and in response thereto produce the master control signal (CTRL) if and only if the first and second control signals (CTRL1; CTRL2) fulfil an identity criterion.

2. The brake controller (100) according to claim 1, wherein each of the first and second control signals (CTRL1; CTRL2) may exclusively attain discrete values, which range from a minimum value to a maximum value, and the gatekeeper unit (130) is configured to consider the identity criterion as fulfilled if and only if the first and second control signals (CTRL1; CTRL2) attain the same discrete value, and if the identity criterion is fulfilled:
produce the master control signal (CTRL) at a value being identical to said same discrete value.

3. The brake controller (100) according to claim 1, wherein
the master control signal (CTRL) is configured to control an electric motor (141) such that the electric motor (141) mechanically influences at least one friction member (142) to move relative to a rotating member (143) of the electrically operated brake unit (140); and
each of the first and second control units (110; 120) is configured to receive a feedback signal (FB) from the electrically operated brake unit (140), which feedback signal (FB) is produced by a force sensor (144) of the electrically operated brake unit (140).

4. The brake controller (100) according to claim 3, wherein each of the first and second control units (110; 120) is further configured to:
produce a respective first and second acknowledgement message (ACK1, ACK2) in response to the feedback signal (FB), the first and second acknowledgement messages (ACK1, ACK2) confirming that the braking operation has been effected;
exchange the first and second acknowledgement messages (ACK1, ACK2) with one another; and
produce, exclusively in one of the first and second control units (110; 120), a master acknowledgement message (ACK) if and only if the first and second acknowledgement messages (ACK1, ACK2) agree on a magnitude of a force at which the braking operation was effected, which magnitude is indicated by each of the first and second acknowledgement messages (ACK1, ACK2) in first and second data fields respectively.

5. The brake controller (100) according to claim 4, wherein the first and second acknowledgement messages (ACK1, ACK2) are considered to agree on said magnitude if a checksum calculated in one (110) of the first and second control units based on the first data field in one of the first and second acknowledgement messages (ACK1) matches the second data field in the other one of the first and second acknowledgement messages (ACK2), which said other one message was produced in the other one (120) of the first and second control units.

6. The brake controller (100) according to claim 3, further comprising
a first motor diagnostic unit (231) configured to receive at least one root diagnostic signal (MD) from the electric motor (141), which at least one root diagnostic signal (MD) indicates one or more electromagnetic characteristics of the electric motor (141), and in response to the at least one root diagnostic signal (MD) produce a first motor diagnostic signal (MD1);
a second motor diagnostic unit (232) configured to receive the at least one root diagnostic signal (MD) from the electric motor (141) and in response thereto produce a second motor diagnostic signal (MD2); and
wherein the first control unit (110) is configured to:
receive the first motor diagnostic signal (MD1);
produce a first motor-diagnostic acknowledgement message in response thereto, which first motor-diagnostic acknowledgement message reflects the one or more electromagnetic characteristics of the electric motor (141);
forward the first motor-diagnostic acknowledgement message to the second control unit (120); and
receive a second motor-diagnostic acknowledgement message from the second control unit (120), and
wherein the second control unit (120) is configured to:
receive the second motor diagnostic signal (MD2);
produce the second motor-diagnostic acknowledgement message in response thereto, which second motor-diagnostic acknowledgement message reflects the one or more electromagnetic characteristics of the electric motor (141); and
forward the second motor diagnostic acknowledgement message to the first control unit (110); and
produce, exclusively in one of the first and second control units (110; 120), a master motor-diagnostic acknowledgement message if and only if the first and second motor diagnostic acknowledgement messages agree on the one or more electromagnetic characteristics of the electric motor (141) reflected by the first and second motor diagnostic acknowledgement messages respectively.

7. The brake controller (100) according to claim 3, further comprising
a first force-sensor diagnostic unit (241) configured to receive a source diagnostic signal (FSD) from the force sensor (144), which source diagnostic signal (FSD) indicates a functionality characteristic of the force sensor (144), and in response to the source diagnostic signal (FSD) produce a first force-sensor diagnostic signal (FSD1);
a second motor diagnostic unit (242) configured to receive the source diagnostic signal (FSD) from the electric motor (141) and in response thereto produce a second force-sensor diagnostic signal (FSD2); and
wherein the first control unit (110) is configured to:
receive the first force-sensor diagnostic signal (FSD1);
produce a first force-sensor diagnostic acknowledgement message in response thereto, which first force-sensor diagnostic acknowledgement message reflects the functionality characteristic of the force sensor (144);
forward the first force-sensor diagnostic acknowledgement message to the second control unit (120); and
receive a second force-sensor diagnostic acknowledgement message from the second control unit (120), and
wherein the second control unit (120) is configured to:
receive the second force-sensor diagnostic signal (FSD2);
produce the second force-sensor diagnostic acknowledgement message in response thereto, which second force-sensor diagnostic acknowledgement message reflects the functionality characteristics of the force sensor (144); and
forward the second force-sensor diagnostic acknowledgement message to the first control unit (110); and
produce, exclusively in one of the first and second control units (110; 120), a master force-sensor diagnostic acknowledgement message if and only if the first and second force-sensor diagnostic acknowledgement messages agree on the functionality characteristics of the force sensor (144) reflected by the first and second force-sensor diagnostic acknowledgement messages respectively.

8. The brake controller (100) according to claim 7, where the source diagnostic signal (FSD) comprises at least one of:
a first data field indicating a temperature of at least one component in the electrically operated brake unit (140), and
a second data field indicating at least one acceleration parameter reflecting a movement of the electrically operated brake unit (140) in at least one dimension.

9. The brake controller (100) according to claim 1, wherein:
the first control unit (110) is further configured to produce at least one first status signal (CD1) reflecting at least one of at least one operation parameter indicating at least one functional status of at least one internal component of the first control unit (110) and at least one environment parameter indicating at least one milieu aspect concerning the first control unit (110);
the second control unit (120) is further configured to produce at least one second status signal (CD2) reflecting at least one of at least one operation parameter indicating at least one functional status of at least one internal component of the second control unit (120) and at least one environment parameter indicating at least one milieu aspect concerning the second control unit (120), and
the brake controller (100) comprises a common diagnostic unit (250) configured to:
receive the first and second status signals (CD1; CD2); and
produce an alarm message (A) if at least one of the first and second status signals (CD1; CD2) indicates at least one of:
at least one malfunctioning internal component, and
at least one milieu aspect being outside an acceptable range.

10. The brake controller (100) according to claim 1, comprising:
a first voltage module (210) arranged to receive a supply voltage (V) and in response thereto provide at least one first output voltage (V1) to the first control unit (110); and
a second voltage module (220) arranged to receive the supply voltage (V) and in response thereto provide at least one second output voltage (V2) to the second control unit (120).

11. The brake controller (100) according to claim 10, wherein each of the first and second voltage modules (210; 220) comprises:
a respective over voltage detector configured to:
monitor the supply voltage (V), and if the supply voltage (V) exceeds a first threshold level,
generate an over voltage alarm; and
a respective under voltage detector configured to:
monitor the supply voltage (V), and if the supply voltage (V) falls below a second threshold level,
generate an under voltage alarm.

12. The brake controller (100) according to claim 1, wherein the state machine (121) is implemented by an integrated circuit.

13. The brake controller (100) according to claim 12, wherein the integrated circuit is a field-programmable gate array, which is designed using a programming language being different from and logically unrelated to a programming language used to generate the computer program running on the processing circuitry (111).

14. The brake controller (100) according to claim 1, wherein the gatekeeper unit (130) comprises parallel branches of switches of which parallel branches comprises:
a first branch comprises a first switch (131a) controllable to be open or closed in response to the first control signal (CTRL1) and a second switch (132a) controllable to be open or closed in response to the second control signal (CTRL2), and
a second branch comprises a third switch (131b) controllable to be open or closed in response to the first control signal (CTRL1) and a fourth switch (132b) controllable to be open or closed in response to the second control signal (CTRL2),
which first and second branches each is configured to pass through the master control signal (CTRL) if and only if the first and second control signals (CTRL1; CTRL2) fulfil the identity criterion when the first and second switches (131a, 132a) and the third and fourth switches (131b, 132b) respectively are closed.

15. The brake controller (100) according to claim 14, wherein the first, second, third and fourth switches (131a, 132a, 131b, 132b) are implemented in metal-oxide-semiconductor field-effect transistor, MOSFET, technology.
